(19) United States
(12) Patent Application Publication
(10) Pub. No.: US 2019/0254315 A1
(43) Pub. Date: Aug. 22, 2019

(54) Method of Reducing Moisture in Brewers' Spent Grain

(71) Applicant: Treasure8 LLC, San Francisco, CA (US)

(72) Inventor: Gregory J. Willis, Pleasant Hill, CA (US)

(21) Appl. No.: 15/965,747

(22) Filed: Apr. 27, 2018

Related U.S. Application Data
(60) Provisional application No. 62/632,374, filed on Feb. 19, 2018.

(51) Int. Cl. A23L 3/005; A23L 3/54; C12G 3/02

(52) U.S. Cl. CPC A23L 3/0055; C12G 3/02; A23L 3/54

(57) ABSTRACT

A method of reducing a moisture content of brewers' spent grain (BSG) comprising exposing an amount of BSG to infrared radiation.

### FIELD

Food processing and production

### BACKGROUND

Humans have brewed and consumed beer for more than five thousand years. Over this great length of time the brewing process has changed little. The brewer starts with barley grain that is sprouted and then dried to form a malted barley. This malted barley is then milled, combined with water, and heated until it reaches temperatures upwards of 170 F. This steeping of the grain promotes enzymatic hydrolysis of the starch from the malt. During this process, the starch is converted to fermentable sugars, non-fermentable sugars, and polypeptides and amino acids are released from proteins. This enzymatic conversion stage, known as mashing, produces a sweet liquid known as wort. The wort, rich with available sugars, is separated from the grain and fermented to produce beer.

The main byproduct of the brewing process is the barley which is now referred to as brewers spent grain (BSG). The BSG generally has a moisture content between 70%-80%. The combination of moisture, fermentable sugars and latent heat from the mashing process makes the BSG susceptible to microbial growth and spoilage. Additionally, the high moisture content makes transportation costly due to the unnecessary shipping of “water.”

While the exact chemical composition of BSG varies based upon barley variety, harvest time, malting and mashing conditions, it is considered a waste material rich in the macronutrients of protein (^{˜}20%) and fiber (^{˜}70%) with many additional vitamins and minerals still available.

Given the nutritional benefits that the BSG possesses a method is needed to remove the water and stabilize the BSG for use as in ingredient for human consumption. This will have the secondary advantage of reducing both the product weight and volume thus making it more economical for storage and transport.

A variety of physical methods exist for stabilizing the BSG. Freezing is one option but this would require a tremendous amount of energy to take something latent with water at high temperatures to convert it to a frozen product. Additionally, it would still have the same amount of residual water and not improve the weight or volume of the BSG for transport.

Freeze drying is another option that would succeed in removing the water thus reducing the water weight. But the energy inputs and limited batch style processing of freeze drying would reduce the economic value of any product created.

Patents filed at the end of the 19^{th} century focus on rotary drum dryers as a mechanical means for drying the BSG. These are inefficient from the conduction and convection transfer of heat while in contact with heated metal drums and the air surrounding them.

Another more current option would be to use continuous tunnel ovens for drying of the BSG. These run the risk of long dwell times and the potential creation of new flavors with elevated temperatures and inconsistent heating areas.

More recently some researchers have evaluated the use of thin layer drying with superheated steam as a modern method because they claim advantages in reduction in environmental impact, improved drying efficiency, elimination of fire or explosion risk, and enhanced recovery of organic compounds.

A membrane filter press represents yet another alternative where the BSG is pressed and then vacuum dried but only to 20-30% moisture. The risk of future spoilage and food safety concerns is not alleviated with such high moisture levels.

### BRIEF DESCRIPTION OF DRAWINGS

FIG. 1 is a flow chart of an embodiment of a method of reducing moisture in BSG.

FIG. 2 shows a schematic side view of a drying machine utilizing infrared emitters and having a gear driven belt to move product through the machine.

### DETAILED DESCRIPTION

A method is disclosed for quickly drying brewers' spent grain (BSG) with an energy efficient infrared process that stabilizes the grain into a protein and fiber rich ingredient available for human consumption. The stabilized grain can be milled into flour for use as an independent ingredient or screened into its two fractions of protein (smaller) and fiber (larger) for use fortifying other ingredients. Potential baking applications of the BSG flour include but are not limited to: breads, muffins, cookies, snacks, mixed grain cereals, pastas, cakes, waffles, pancakes, tortillas, doughnuts and brownies.

Infrared radiation is electromagnetic energy with wavelengths longer than visible light but shorter wavelengths than microwave energy. In one embodiment, a method of drying BSG uses the medium (2-4 μm) to far (4-100 μm) infrared wavelengths with peak wavelengths occurring below 10 μm. Without wishing to be bound by theory, it is believed that the infrared energy excites or increases the vibrational frequency of polar molecules such as water in the BSG creating heat. When used with food, infrared energy is transmitted as electromagnetic waves and then converted to heat when it excites the polar molecules in the BSG. The heat created within the BSG from infrared energy causes water molecules to vaporize and escape as a gas allowing moisture to be removed from the BSG. Since infrared does not heat the air and surrounding medium, the energy transfer is highly efficient. Although infrared generally has a limited ability to penetrate deep into a material, the small particle size of the BSG lends itself well to this form of radiation.

Infrared emitters can be either electrical or gaseous. The gaseous type can either be open flame or flameless. The fuel source for both of the gaseous types can either be propane or natural gas. The open flame release infrared radiation through the combustion process and waste energy through the creation of visible light. Catalytic IR emitters pass their fuel source across a platinum catalyst in the presence of oxygen to produce IR radiation with the byproducts of carbon dioxide and water vapor. Because NOx (mono-nitrogen oxides) or carbon monoxide are not created in the catalytic process, it is an attractive method of thermal processing in today's restricted regulatory environment that exists for manufacturing industries.

In one embodiment, a method of reducing a moisture content of BSG includes exposing a film or bed of BSG particles to infrared radiation. A dwell time and proximity of infrared radiation emitter(s) are selected to achieve a desired moisture reduction. Representatively, wet BSG (e.g., 60-80% moisture content) disposed as a film or bed having a thickness on the order of 5 to 25 millimeters (mm) is utilized with an infrared emitter positioned 10 centimeters (cm) to 20 cm from the bed. A dwell time of infrared radiation at 2-10 μm of 3 to 6 minutes results in 70 to 90% reduction in the moisture content in the BSG film or bed.

### Example

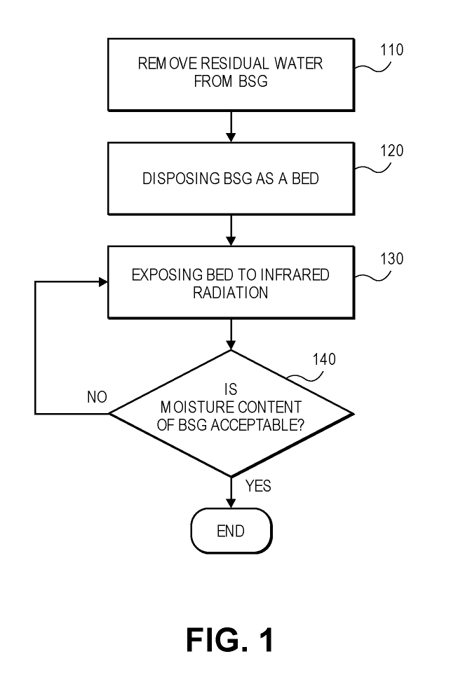

The following is a representative example of a method of reducing a moisture content in BSG. FIG. 1 presents a flow chart of the method.

In one experiment the initial moisture content of the malted barley was 4.8%. The grain was prepared in the following manner:

Step 1: Water was heated to 152 F. The barley was poured into the water at a ratio of one pound of barley to one quart of water. The barley was covered for one hour and stirred every fifteen minutes and then drained.

Step 2: Additional water was heated to 170 F and poured over the grain at the ratio of one gallon of water to one pound of grain and then drained resulting in BSG. The moisture content of the BSG was 72.6%.

### Pressing

A hydraulic press was used to remove the residual water from the BSG in order to reduce the amount of drying that needed to occur (block 110, FIG. 1). Following this process the moisture content had been reduced to 63.8%. Other means could also be employed to achieve similar moisture reductions (e.g., 5 to 15 percent moisture reduction) such as a continuous centrifuge or other mechanical methods for water extraction.

### Drying

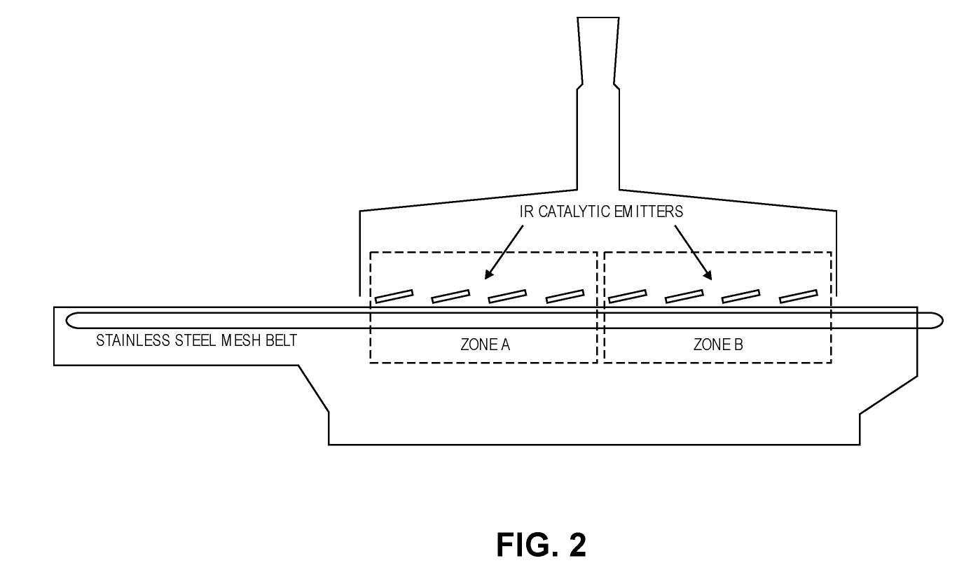

The pressed BSG was loosely packed as a bed (approximately 10 mm thick) onto woven Teflon mats that lined insides of stainless steel carrier trays (block 120, FIG. 1). The trays were placed into a drying machine. FIG. 2 shows a representative embodiment of a drying machine (block 130, FIG. 1).

The drying machine consists of eight catalytic infrared emitters above (approximately 18 cm) a moving stainless steel mesh belt. Each emitter was configured at a slope of approximately 15 degrees to allow oxygen to pass over the platinum in the presence of natural gas and support the catalytic reaction necessary for creating infrared radiation.

The eight emitters were divided into two zones with an initial zone A with four emitters and a second zone B with the same configuration. The two zones have independent controls of a natural gas flow.

The total length of the drying machine with both zones is approximately sixteen feet. Setting the variable frequency drive at thirty hertz for the belt motor speed created a preferred exposure time to the infrared radiation of four minutes (block 130, FIG. 1). Longer duration resulted in the BSG discoloring and starting to burn.

Zone A was configured for 100% natural gas flow in order to remove a majority of the moisture in the first zone while reducing the natural gas flow in Zone B to 65% to have a less intense process and reduce discoloring or burning.

The above-described method contemplated conditions allowing for a desired moisture reduction of BSG through a single pass through the drying machine of FIG. 2. It is appreciated that after a single pass through the drying machine, a moisture content of the BSG may be measured (block 140, FIG. 1). If the moisture content is acceptable, the method is complete. If the moisture content is not acceptable, the bed of BSG may be returned to the drying machine for additional infrared exposure.

### Results

The moisture content of the BSG after the four minute exposure time was measured at 13.7%. The material had been converted to a safe and stable ingredient. The material may then be used as a standalone ingredient for incorporation into bars, granola, cereal, soup mixes or other food items. Further processing is an option for milling the grain into flour. Representatively, the material may be ground into flour for use in baked goods. Further processing of the flour such as through dedicated screen sizing separation could separate the material into its protein and fiber fractions. A protein portion of the material (typically smaller particle size) may representatively be used in any recipe, formula and product that uses plant-based proteins. A fiber portion of the material (typically larger particle size than protein particle size) can be used in any recipe, formula or product that calls for fiber. Finally, both the fiber and protein portions may be combined in a mixture to achieve a desired protein to fiber ratio.

In the description above, for the purposes of explanation, numerous specific details have been set forth in order to provide a thorough understanding of the embodiments. It will be apparent however, to one skilled in the art, that one or more other embodiments may be practiced without some of these specific details. The particular embodiments described are not provided to limit the invention but to illustrate it. The scope of the invention is not to be determined by the specific examples provided above but only by the claims below. In other instances, well-known structures, devices, and operations have been shown in block diagram form or without detail in order to avoid obscuring the understanding of the description. Where considered appropriate, reference numerals or terminal portions of reference numerals have been repeated among the figures to indicate corresponding or analogous elements, which may optionally have similar characteristics.

It should also be appreciated that reference throughout this specification to “one embodiment”, “an embodiment”, “one or more embodiments”, or “different embodiments”, for example, means that a particular feature may be included in the practice of the invention. Similarly, it should be appreciated that in the description various features are sometimes grouped together in a single embodiment, figure, or description thereof for the purpose of streamlining the disclosure and aiding in the understanding of various inventive aspects. This method of disclosure, however, is not to be interpreted as reflecting an intention that the invention requires more features than are expressly recited in each claim. Rather, as the following claims reflect, inventive aspects may lie in less than all features of a single disclosed embodiment. Thus, the claims following the Detailed Description are hereby expressly incorporated into this Detailed Description, with each claim standing on its own as a separate embodiment of the invention.

We claim:

1. A method of reducing a moisture content of brewers' spent grain (BSG) comprising exposing an amount of BSG to infrared radiation.

2. The method of claim 1, wherein the amount of BSG comprises a water content and exposing the amount of BSG to infrared radiation comprises exposing to infrared radiation sufficient to reduce the water content.

3. The method of claim 2, wherein the reduction in water content is 70 percent to 90 percent.

4. The method of claim 2, wherein the infrared radiation comprises a wavelength in the medium to far infrared range.

5. The method of claim 2, wherein the infrared radiation comprises a wavelength in the range of 2 microns to 10 microns.

6. The method of claim 1, wherein prior to exposing the amount of BSG to infrared radiation, the method comprises disposing the amount of BSG as a bed.

7. The method of claim 6, wherein the bed comprises a thickness on the order of 5 millimeters to 25 millimeters.

8. A method comprising:
disposing an amount of BSG as a bed; and
exposing the bed to infrared radiation.

9. The method of claim 8, wherein exposing comprises exposing the bed to infrared radiation for a sufficient time to reduce a moisture content of the bed.

10. The method of claim 8, wherein exposing comprises exposing the bed to infrared radiation for a sufficient time to reduce a moisture content of the bed by 70 percent to 90 percent.

11. The method of claim 8, wherein the infrared radiation comprises a wavelength in the range of 2 microns to 10 microns.

12. The method of claim 11, wherein the bed comprises a thickness on the order of 5 millimeters to 25 millimeters.

13. The method of claim 12, wherein exposing comprises exposing the bed to infrared radiation for 3 minutes to 6 minutes.

14. The method of claim 8, wherein after exposing the bed to infrared radiation, incorporating the amount of BSG as an ingredient in a food product.

15. The method of claim 8, wherein after exposing the bed to infrared radiation, milling the amount of BSG into a flour.
